(19) United States
(12) Patent Application Publication
(10) Pub. No.: US 2009/0098509 A1
(43) Pub. Date: Apr. 16, 2009

(54) Dental tooth extraction implement and method thereof

(76) Inventor: Arthur Kitchings Weathers, Las Vegas, NV (US)

Correspondence Address: Arthur K. Weathers, Suite 130, 1401 Hillshire DR., Las Vegas, NV, 89134, US

(21) Appl. No.: 11/974,486

(22) Filed: Oct. 15, 2007

(51) Int. Cl. A61C 3/00

(52) U.S. Cl. 433/152

(57) ABSTRACT

This application relates to the field of Dentistry, and in more particular to the atraumatic extraction of teeth. The instant invention is a wedge-shaped extraction rod to be inserted into a pre-drilled root. With a wider than thick configuration, the wedge-shaped rod allows the controlled introduction of both clockwise and counterclockwise torque around the vertical axis of the root to induce dislodgment from the natural socket seating, before the subsequent vertical removal of the root.

### FIELD OF THE INVENTION

This application relates to the field of Dentistry, and in more particular to the atraumatic extraction of teeth. The instant invention is a wedge-shaped extraction rod to be inserted into a pre-drilled root. With a wider than thick configuration, the wedge-shaped rod allows the controlled introduction of both clockwise and counterclockwise torque around the vertical axis of the root to induce dislodgment from the natural socket seating, before the subsequent vertical removal of the root.

### DESCRIPTION OF THE RELATED ART

The removal of a tooth has long been done by grasping and wrenching it out of its socket by pliers or special forceps. This introduces unnatural trauma to the jawbone or skull, usually cracking the walls of the involved socket. In recent decades, more sophisticated procedures have been introduced that involve a series of steps requiring particular implements to remove teeth without cracking the living alveolar bone. Because such trauma is reduced or eliminated, these systems have become known as atraumatic procedures. One of the most pertinent systems in current use is the Easy X-Trac methodology of Titan Instruments in Hamburg, N.Y., as recently described in the journal “Implant Dentistry,” 2007, volume 16 Number Two, pages 139-145. Another of similar nature is Benex-Control Extraction System of Meisinger LTD of Centennial, Colo. Details of this system can be currently viewed on the internet at www.osseotech.com/pdf/benex-control.pdf.

Both of these systems involve shearing away the cap or crown of a deadened subject tooth to expose a straight path into the root, or in the case of multi-rooted teeth cutting away sufficient crown to separate the roots from each other. All such exposed roots are removed by drilling down into the root, depending on size and nature, about 8 to 10 mm. The final hole is about 1.5 mm in diameter. Subsequently a threaded tap is screwed into the drilled hole, either by hand or by mechanical assistance. Finally, vertical force is introduced by specialized mechanical lifting agents that pull the tooth straight up by attaching to the tap, sufficient to break the connection between the periodontal ligaments that holds the root in the socket. The desired goal, of not cracking the socket walls, is usually achieved by both described prior art systems. However, the softer tissue is ripped apart unduly.

### BRIEF DESCRIPTION OF THE INVENTION

The instant invention is a wedge-shaped extraction rod, herein termed a torque-wedge. The torque-wedge can be injection molded with a strong, rigid plastic or metal filled plastic composite compound, or ceramic utilized as the material. It can be inserted without screwing or binding into a prepared hole in the root. Subsequently, when engaged with a handle or lever it can deliver clockwise and counterclockwise force to the vertical axis of the root. The body has the ability to respond to such force by triggering a biological reaction that in effect loosens the attachment of the periodontal ligaments. This loosening happens over the course of about 30 minutes while the patient rests comfortably with the torque-wedge removed. Lastly, the tooth can subsequently be lifted out by hand after the torque-wedge is glued or bonded into the hole by the dentist and subsequently grasped with the fingers.

The use of described prior art atraumatic root extraction is hindered by the use of expensive metal implements, involving threaded taps and vertical lift extractors that must be sterilized between use for different patients. These implements are costly, and thus because they are too expensive to discard, despite autoclaving they always carry the possibility of introducing body fluids from one patient to another. The instant invention is intended to be disposed of after use. Another benefit of the instant invention is that if the socket is to be refilled with a dental implant, the ligament damage sustained from the rotation of the torque-wedge is less than inflicted by the direct vertical lifting of prior art methods, with higher chances for implant success.

It is therefore accordingly an object of the present invention to provide an atraumatic tooth root removal system whereby the root is preponderantly released from the natural binding within the socket before it is vertically extracted.

It is also accordingly an object of the present invention to provide an atraumatic tooth root removal system whereby the expensive metal implements used in prior art systems, involving a threaded tap and mechanical vertical force lifting agents, are eliminated.

It is also accordingly an object of the present invention to provide an atraumatic tooth root removal system whereby the body's own natural processes induce the final release of the involved periodontal ligaments, rather than brute vertical force damaging these tissues and structures, although leaving the socket intact.

It is also accordingly an object of the present invention to provide an atraumatic tooth root removal system whereby the chances for the introduction of a successful implant in the empty socket are increased by inflicting minimal shear damage to periodontal ligament fibers.

### BRIEF DESCRIPTION OF THE DRAWINGS

FIG. 1 is a side view of the instant invention, herein termed a torque-wedge.

FIG. 2 is a front view of the torque-wedge.

FIG. 3 is a top view of the torque-wedge.

FIG. 4 is a bottom view of the torque-wedge.

FIG. 5 is a drawing of the torque-wedge inserted in a prepared jawbone root where the hole is flared in the bucchal-lingal direction.

FIG. 6 is a drawing of the torque-wedge inserted in a prepared jawbone root where the hole is flared in a direction following the gum line holding the teeth.

FIG. 7 is a representation of the torque-wedge in place in a prepared skull root.

FIG. 8 is a representation of the torque-wedge undergoing rotation with a handle or bar.

FIG. 9 is a side view of an alternate embodiment with a rounded neck.

FIG. 10 is a front view of the embodiment of FIG. 9.

FIG. 11 is a top view of the embodiment of FIG. 9.

FIG. 12 is a bottom view of the embodiment of FIG. 9.

FIG. 13 is a basic torque-wedge embodiment without a leg or neck.

FIG. 14 is a basic non-tapered torque-wedge embodiment.

### DETAILED DESCRIPTION OF THE INVENTION

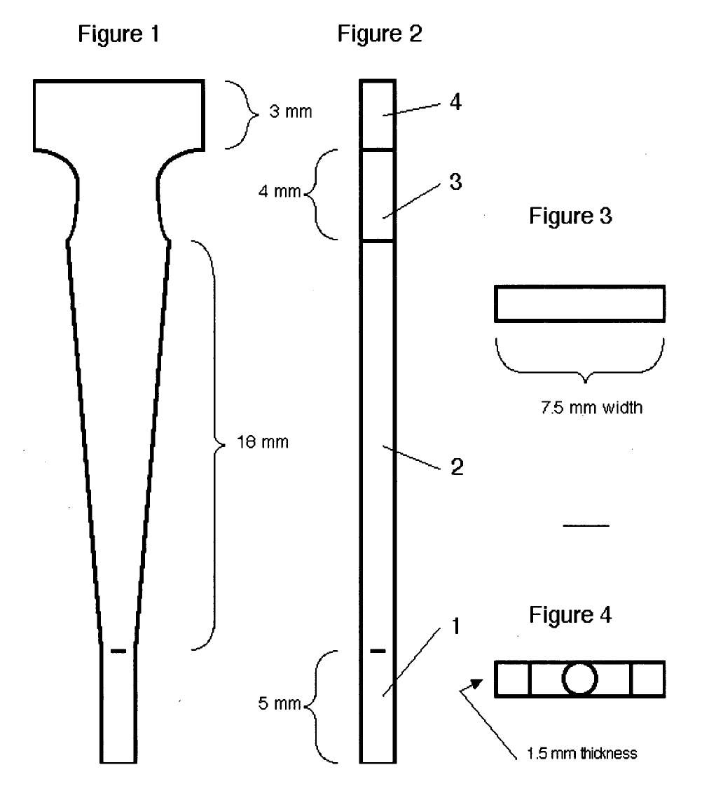

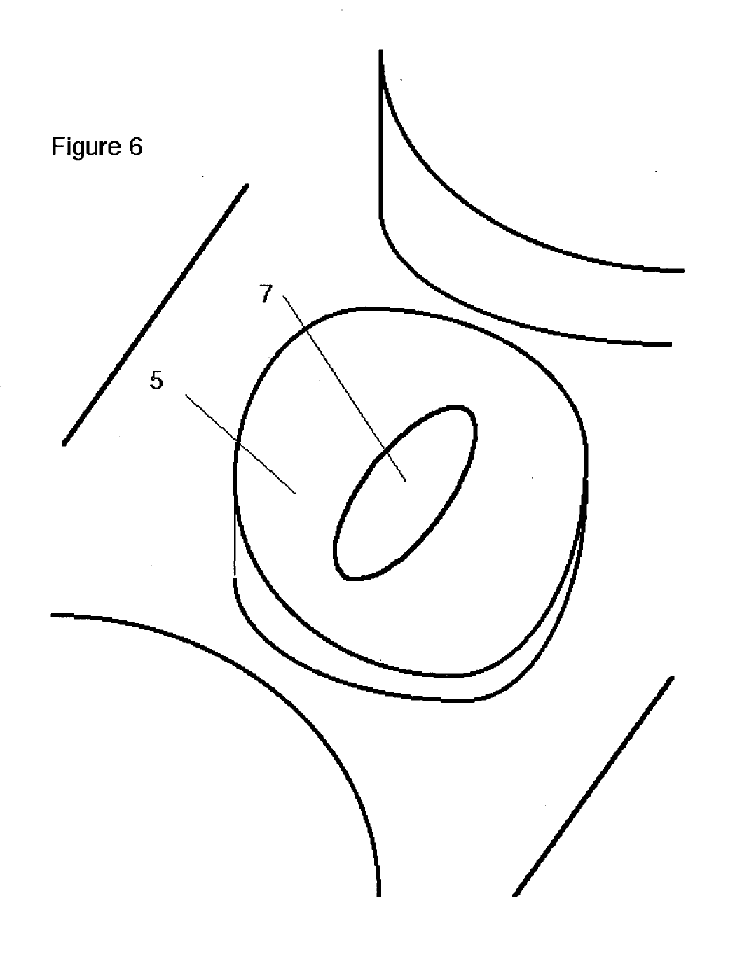

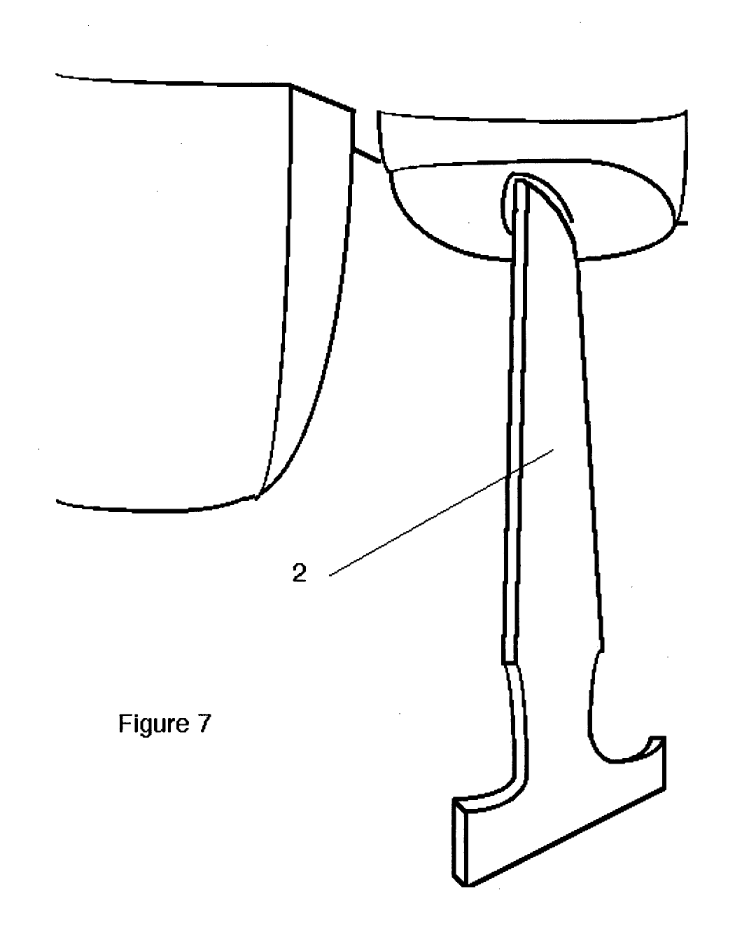

As seen in FIGS. 1 and 2, the preferred embodiment torque-wedge is 30 millimeters long, and has a 5 mm leg (1) below an 18 mm trunk (2) below a 4 mm neck (3) below a 3 mm head (4). The torque-wedge has a thickness of 1.5 mm. After deadening the tooth and removing the crown of the tooth to expose the root, a hole is drilled as in prior art procedures. However, the hole is modified, for example by swinging the drill path in the bucchal (gum) side and the lingal (tongue) directions to flare the hole into a graduated ovoid shape sufficient to allow entry of the lower part of the torque-wedge. This is shown in FIG. 5 where a root (5) has a prepared hole (6). Special drills available to the dental industry allow the drill shaft to remove material in the desired manner. Otherwise, the hole may be flared in any direction strategically preferred by the dentist, such as is shown in FIG. 6 where root (5) has a prepared hole (7) following the gum line. A view of a prepared root in the upper teeth is shown in FIG. 7, with the torque-wedge's trunk (2) snuggly pushed in as far as it can go.

In FIG. 8 the attachment end of a handle (8) is shown with dashed lines for clarity. It is placed over the head (4) of the torque-wedge, in such a manner that the long shaft of the handle points out the mouth of the patient. The handle has an ovoid-shaped cavity designed to allow the head of the torque-wedge to fit inside without undue slipping. Handle (8) is moved by the dentist with a ratcheting motion clockwise about 10 degrees through the circle circumference it could theoretically travel, and quickly returned to its starting position. Immediately the handle is then moved counter-clockwise about 10 degrees, and returned to the starting position. This causes prepared root (5) to twist around the shaft of the torque-wedge, which strains the many thousands of fibers, collectively known as the periodontal ligament, beyond their ability to maintain perfect attachments to the root.

By lifting the handle away, and next grasping the torque-wedge with the fingers and lifting it out of the tooth's root, the patient is allowed to rest for 30 minutes. In this time the body releases various protein secretions, including collagenase, which furthers the release of attachment fibers from the root surface. In effect, the root becomes pliable and released much more willingly than when the root is immediately pulled upward to detach the periodontal ligament as is done with the prior art threaded tap and lifter mechanism. After 30 minutes, the torque-wedge is coated with a prior art fast-setting epoxy-resin and reinserted into the hole as before. The entire root is subsequently pulled upward with fingers grasping the top of the torque-wedge.

Disclaimer: The instant invention is suitable for normal teeth and root systems. Sometimes abnormal cases are present where the root was damaged in the patient's earlier lifetime, and has undergone ankylosis and fused to the socket. These roots will not smoothly rotate the recommended 10% as cited earlier. For these cases traditional dental surgery may be employed to cut out the root, or in lesser cases of severity the dentist may choose to try a vertical lifting device inserted under the head of the bonded torque-wedge to attempt to pull the root. It is a commonality that both the instant invention and the prior art cannot extract an abnormal root that has inordinately fused to the socket, as serious damage could be inflicted on the patient if the root is now fused into being part of the bone system.

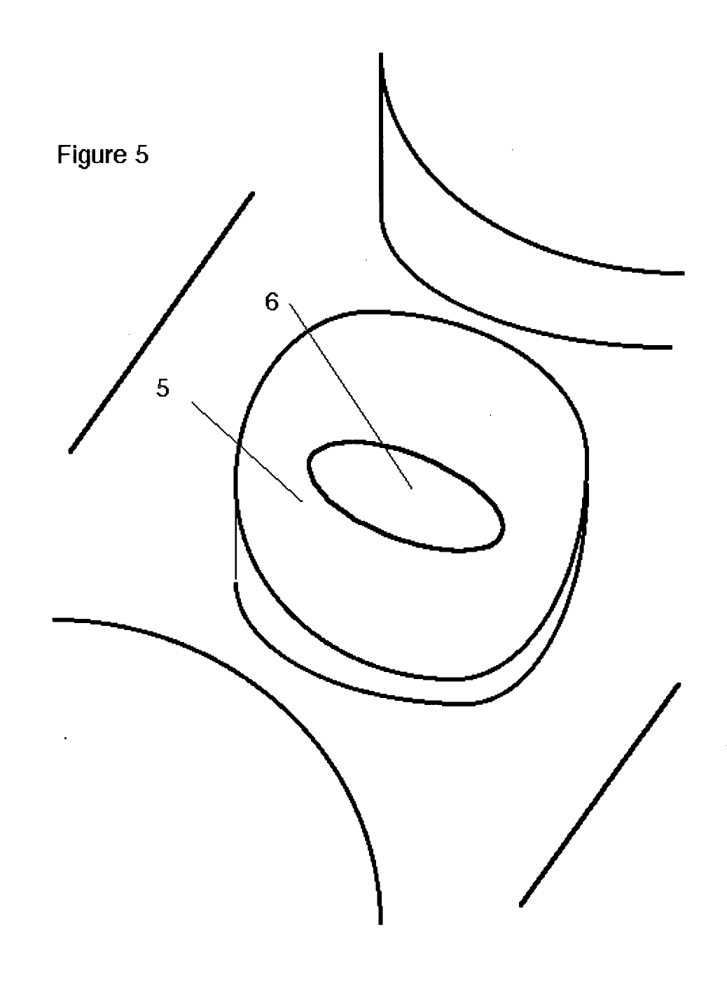

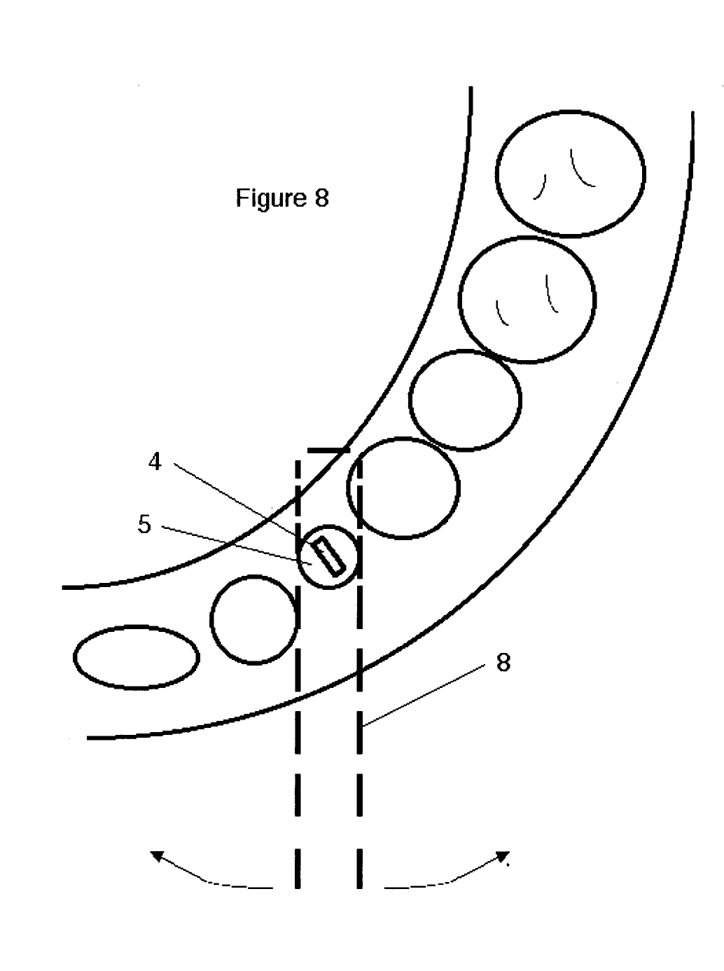

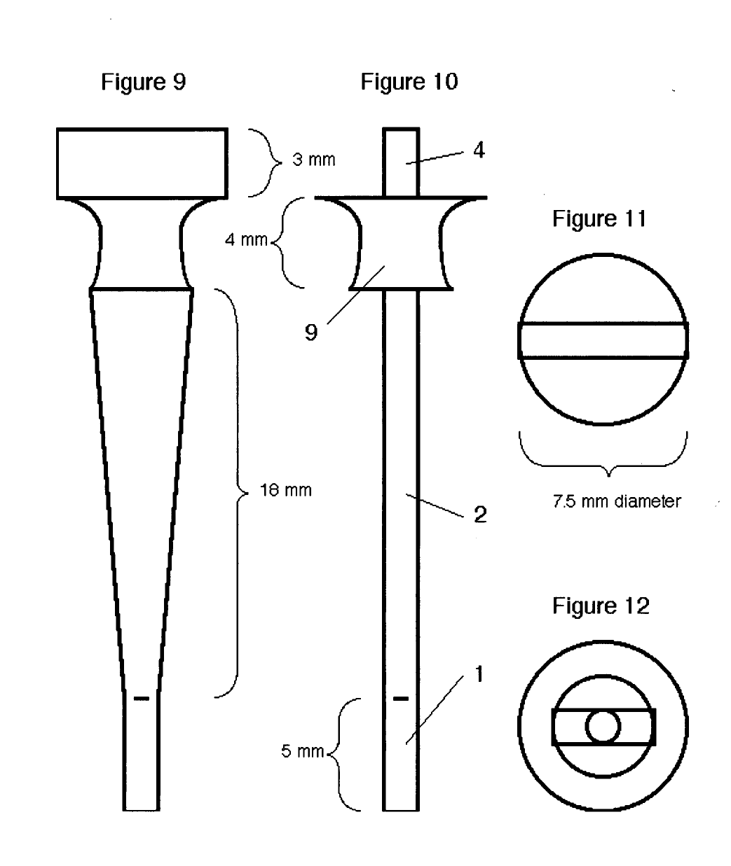

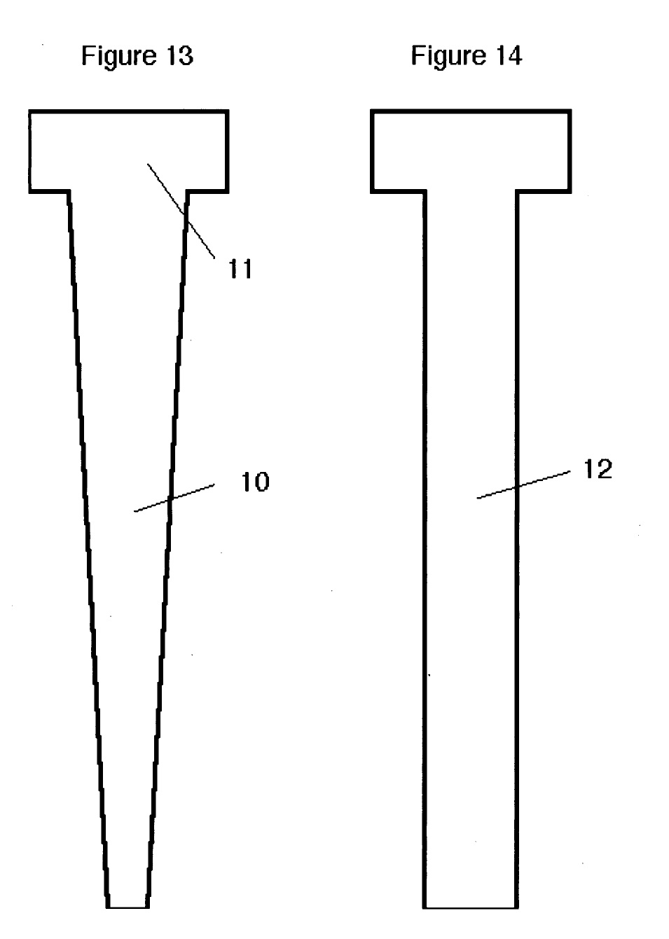

The torque-wedge may be varied as to length and thickness from the dimensions given in the preferred embodiment of FIGS. 1, 2, 3, and 4, or in the composition of matter from which it is formed. The four sub-components of the torque-wedge can be varied as to shape. For instance FIGS. 9, 10, 11, and 12 show an alternate embodiment in which neck (9) is formed with a round diameter. The head has the function of engaging with a handle to allow rotation of the root inside its socket. It can be any form that complies with this function, and positioned at any angle relative to the rest of the torque-wedge that also complies with this function. The neck as a separate entity may be eliminated if the head still retains its ability to be engaged with a handle for introduction of lateral rotation prior to lifting, and retains sufficient size and flare to allow it to be grasped or engaged for said lifting. The leg as a separate entity may be eliminated if the tapered trunk is extended all the way to the lower extremity. Such a basic embodiment of the invention is shown in FIGS. 13 and 14, where trunk (10) or trunk (12) connects directly with head (11). The lower trunk may have a corrugated surface to lessen slippage when bonded into the root for final lifting out of the socket. The novelty of the trunk primarily derives from being wider than deep and lacking threads for rotational insertion by screwing. Such threads, because they would continue to bite into tooth structure if torqued clockwise, or loosen if torqued counterclockwise, would defeat the purpose of inducing sufficient clockwise and counterclockwise lateral stress to the root, as is fulfilled by the instant invention. The order in which clockwise and counterclockwise torque is applied is inconsequential.

This invention should not be confined to the embodiments described, as many modifications are possible to one skilled in the art. This paper is intended to cover any variations, uses, or adaptations of the invention following the general principles as described and including such departures that come within common practice for this art and fall within the bounds of the claims appended herein.

I claim:

1. An extraction rod for the generation of torque used for rupturing periodontal ligament tissue from a root of a tooth,
said extraction rod with a trunk formed as one end and a head formed as the other end,
said head greater in width or depth than said trunk,
said trunk having a greater length than breadth,
said trunk having a greater width than depth.

2. The extraction rod of claim 1,
with said width of said head greater than the width of said trunk.

3. The extraction rod of claim 1,
with said depth of said head greater than the depth of said trunk.

4. The extraction rod of claim 1,
with said trunk tapering in the direction moving away from said head,
such that said width decreases with greater distance from said head.

5. The extraction rod of claim 4,
with said tapered trunk having a second portion present within the remaining measure of said length of said trunk,
with said second portion positioned farther from said head than said tapered portion,
with said second portion not tapered, such that said width does not decrease with greater distance from said head.

6. The extraction rod of claim 5,
with said second portion of said trunk round in shape, such that said width is the same as said depth.

7. The extraction rod of claim 1,
with said head having a second portion between said head and said trunk,
with said second portion of less width or less depth than said head,
with said second portion of a different width or depth than said trunk.

8. The extraction rod of claim 7,
with said second portion of said head of less width than said head,
with said second portion of said head of a greater depth than the depth of said head.

9. The extraction rod of claim 8,
with the circumference shape of said second portion circular such that said width and said depth of said second portion is the same.

10. The extraction rod of claim 1,
with said extraction rod composed of any solid composition of matter other than pure metal.

11. The extraction rod of claim 10,
with said solid composition of matter plastic, ceramic, or particle-metal filled plastic.

12. The extraction rod of claim 1,
with said extraction rod composed of a solid pure metal composition of matter.

13. The extraction rod of claim 1,
with the surface of said trunk corrugated or rough.

14. A method for extracting an exposed root of a tooth of a patient by rupturing periodontal ligament tissue attached to said root prior to said extraction of said root,
with a step whereby a drilled hole into said root is flared by a dentist such that the opening of said hole is longer in a given direction than the direction moving 90 degrees from the line established by said longer direction,
with a further step whereby an extraction rod is partially inserted into said drilled hole, said extraction rod with an insertion trunk formed as one end and a head formed as the other end, said head greater in width or depth than said trunk, said trunk having a greater length than breadth, said trunk having a greater width than depth,
with a further step whereby a handle with a connection cavity on or near one end is brought into flush contact with said head of said extraction rod,
such that said cavity contains said head of said extraction rod, and such that said head cannot spin within said cavity when said handle is rotated in the plane 90 degrees to the spin axis of said extraction rod,
with a further step whereby said handle is rotated by said dentist from the starting position either in a clockwise direction or a counterclockwise direction 10 degrees of a complete circle, and returned to said starting position, whereby said periodontal ligament tissue is strained excessively, with a further step whereby said handle is again rotated by said dentist in the opposite direction 10 degrees relative to said previous step, and returned to said starting position,
with a further step whereby said handle is lifted off of said head of said extraction rod and removed from the mouth of said patient,
with a further step whereby said extraction rod is lifted out of said flared hole and removed from the mouth of said patient,
with the further step of allowing said patient to rest for a timed duration,
with a further step whereby said insertion trunk of said extraction rod is coated with an activated binding agent by said dentist and reinserted back into said flared hole in said hole and allowed to congeal,
with a final step whereby said insertion rod is grasped or engaged by said dentist and lifted vertically from said socket.

15. The method of claim 14,
with said activated binding agent a two-part epoxy-resin.

16. The method of claim 15,
with said epoxy-resin having a set time of more than thirty seconds when said activation is commenced, and less than three minutes for completion.

17. The method of claim 14,
with said timed duration of said patient's rest lasting approximately thirty minutes.

18. The method of claim 14,
with said trunk tapering in the direction moving away from said head,
such that said width decreases with greater distance from said head.

19. The method of claim 18,
with said tapered trunk having a second portion present within the remaining measure of said length of said trunk,
with said second portion positioned farther from said head than said tapered portion,
with said second portion not tapered, such that said width does not decrease with greater distance from said head.

20. The method of claim 14,
with said head having a second portion between said head and said trunk,
with said second portion of less width or less depth than said head,
with said second portion of a different width or depth than said trunk.
